(19) United States
(12) Patent Application Publication
(10) Pub. No.: US 2010/0178510 A1
(43) Pub. Date: Jul. 15, 2010

(54) FINE METAL PARTICLES AND BIOMATERIAL-EXTRACTING MAGNETIC BEADS, AND THEIR PRODUCTION METHODS

(75) Inventors: Yasushi Kaneko, Kumagaya-shi (JP); Shigeo Fujii, Kumagaya-shi (JP); Hisato Tokoro, Kumagaya-shi (JP); Takashi Nakabayashi, Kumagaya-shi (JP); Mariko Adachi, Kumagaya-shi (JP)

Correspondence Address: SUGHRUE MION, PLLC, 2100 PENNSYLVANIA AVENUE, N.W., SUITE 800, WASHINGTON, DC, 20037, US

(73) Assignee: HITACHI METALS, LTD., Minato-ku, Tokyo (JP)

(21) Appl. No.: 12/304,055

(22) PCT Filed: Jun. 20, 2007
(86) PCT No.: PCT/JP2007/062450

§ 371 Date: Jan. 13, 2009

(30) Foreign Application Priority Data
Jun. 20, 2006 (JP) 2006-169656

(51) Int. Cl. B32B 15/02; B32B 5/16

(52) U.S. Cl. 428/403; 427/127

(57) ABSTRACT

Fine metal particles each comprising a magnetic metal core particle and two or more coating layers, the outermost layer among the two or more coating layers containing an oxide of silicon and aluminum at an Al/Si atomic ratio of 0.01-0.2, and a method for producing fine metal particles comprising the steps of coating each primary particle comprising a magnetic metal core particle and a first coating layer with a mixture of silicon alkoxide and aluminum alkoxide, and then hydrolyzing the silicon alkoxide and the aluminum alkoxide, thereby forming a second coating layer comprising an oxide of silicon and aluminum at an Al/Si atomic ratio of 0.01-0.2.

### FIELD OF THE INVENTION

The present invention relates to fine metal particles and magnetic beads suitable as carriers, etc. for extracting biomaterials such as nucleic acids, proteins and cells, and their production methods.

### BACKGROUND OF THE INVENTION

Conventionally known as technologies for purifying and separating nucleic acids, proteins, cells, etc. are a column separation method, a centrifugal separation method, an electrophoresis method, a magnetic separation method, etc. The magnetic separation method uses magnetic beads each having a functional group, which is called a linker bonding to a specific biomaterial, on the surface, or magnetic beads each having a silicon oxide coating layer on the outermost surface. These magnetic beads are mixed with a solution containing a biomaterial such as a nucleic acid, a protein, cells, etc., to adsorb the biomaterial on the surface, and separated from the liquid by a magnetic force to recover the biomaterial. The magnetic bead method is advantageous in easily recovering a biomaterial in a short period of time with simple equipment.

JP 2001-78761 A discloses a nucleic-acid-bonding, magnetic silica particle carrier comprising superparamagnetic metal oxide coated with silica, which has a particle diameter of 0.5-15.0 μm, a pore diameter of 50-500 nm, and a pore volume of 200-5000 mm³/g. Because the magnetic beads comprising a superparamagnetic metal oxide have lower magnetic properties than those of a magnetic metal, they need a long period of time for solid-liquid separation with a magnetic force in the separation and purification step of a target material, suffering a low purification efficiency of the target material because of low magnetic response.

JP 2004-135678 A discloses magnetic beads each comprising a magnetic particle of a metal or its oxide coated with glass comprising at least one of SiO₂, B₂O₃, K₂O, CaO, Al₂O₃ and ZnO, more than 75% by weight of the particles having particle sizes of 0.5-15 μm. JP 2004-135678 A describes that carbonyl iron is particularly suitable for metal core particles. Although the magnetic beads each comprising a carbonyl iron core particle exhibit excellent magnetic properties, sufficient corrosion resistance cannot be obtained when the metal core particles are simply coated with silicon oxide. Particularly when magnetic beads are immersed in a high-concentration solution (dissolving and adsorbing liquid) containing a chaotropic salt (a guanidine salt, etc. specifically adsorbing an extracted material such as a nucleic acid and silicon oxide) in a step of separating and purifying a biomaterial, their magnetic properties are deteriorated by the oxidation of a metal and the elution of the metal into the solution. Also, when the eluted magnetic metal forms a complex with a buffer solution, the separation and purification of a biomaterial is hindered. Accordingly, magnetic beads having high corrosion resistance are desired.

To solve the above problems, EP 1568427 A discloses fine metal particles each comprising a magnetic metal core, a first coating layer based on carbon and/or boron nitride and formed on the core, and a second coating layer based on silicon oxide and formed on the first coating layer. Because of high chemical stability and saturation magnetization, the fine metal particles exhibit a high magnetic separation speed in a step of separating and purifying biomaterials. Although it is required that magnetic beads for use in the extraction of biomaterials such as nucleic acids are chemically stable and can conduct quick magnetic separation with a high collecting rate of nucleic acids, etc., the fine metal particles described in EP 1568427 A are not necessarily sufficient in the collection of nucleic acids, needing more improvement.

JP 2001-78790 A (corresponding to U.S. Pat. No. 5,234,809) discloses a method for extracting a nucleic acid using silica particles bonded to the nucleic acid in the presence of a chaotropic material. JP 2001-78790 describes that smaller silica particles have larger effective areas bonding to a nucleic acid, more effective to collect the nucleic acid. However, for instance, when as small particles as 0.2-10 μm in diameter are used for the extraction of a human whole blood, as in the case of a liquid containing a large amount of a nucleic acid or in the case of extracting a long-chain nucleic acid such as a human genome, aggregates (complex of the nucleic acid and silica particles) are formed, resulting in extremely reduced redispersibility of particles and thus lowered nucleic-acid-recovering performance. To solve such problem, JP 2001-78790 A describes, it is effective to use as large particles as 2-200 μm, for instance. However, large particles are sedimented in a solvent in the extraction step of a nucleic acid, resulting in low bonding efficiency with the nucleic acid.

### OBJECT OF THE INVENTION

Accordingly, an object of the present invention is to provide fine metal particles and magnetic beads having excellent chemical stability even when a magnetic metal having high saturation magnetization is used for core particles, and also having excellent extractability of biomaterials such as nucleic acids, etc.

### DISCLOSURE OF THE INVENTION

As a result of extensive investigation in view of the above object, the inventors have found that in fine metal particles each having a magnetic metal core particle and two or more coating layers, the inclusion of aluminum oxide in a silicon-oxide-based outermost layer drastically improves a nucleic-acid-recovering ratio. The present invention has been completed based on such finding.

Thus, each of the fine metal particles of the present invention comprises a magnetic metal core particle and two or more coating layers, the outermost layer among the two or more coating layers comprising an oxide of silicon and aluminum at an Al/Si atomic ratio of 0.01-0.2. With aluminum added to silicon oxide, a strong coating can be formed.

The bonding energy of Si₂ₚ in the fine metal particles measured by X-ray photoelectron spectroscopy is preferably 102.4-103.4 eV. With the bonding energy of Si₂ₚ constituting the coating layer in the above range, the extractability of a biomaterial is improved.

The 50% particle size [median diameter (d50) by volume] of the fine metal particles is preferably 0.1-10 μm. The 90% particle size (90% cumulative particle size by volume) of the fine metal particles is preferably 0.15-15 μm.

The core particle preferably comprises at least one magnetic metal selected from the group consisting of Fe, Co and Ni.

The fine metal particles of the present invention preferably have a zeta potential of −40 mV to −10 mV in a 0.01-M aqueous KCl solution of pH 7.5. With the zeta potential in this range, the fine metal particles exhibit high extractability of biomaterials.

The fine metal particles of the present invention preferably have saturation magnetization of 80-200 A·m²/kg. With the saturation magnetization in this range, the recovery of a biomaterial with a magnetic force can be conducted in a short period of time. When the saturation magnetization is less than 80 A·m²/kg, the recovery of a biomaterial takes a long period of time. The coating of magnetic metal particles with an inorganic material, etc. makes the saturation magnetization lower than when only fine, magnetic metal particles are used. The more preferred saturation magnetization of 100-200 A·m²/kg reduces the time of recovering biomaterials with a magnetic force, resulting in high extractability of biomaterials.

The innermost coating layer among the two or more coating layers, which is in contact with the magnetic metal core particle, is preferably based on at least one element selected from the group consisting of Si, V, Ti, Al, Nb, Zr and Cr. These elements with high crystallinity produce a dense coating layer. With the above coating layer, the fine metal particles keep high stability even in a solvent, though the core particles are made of a magnetic metal. Accordingly, even when the fine metal particles are immersed in an alkaline solution during the formation of the outermost coating layer by an oxide of silicon and aluminum, the elution and corrosion of the metal can be prevented.

The magnetic beads of the present invention are biomaterial-extracting magnetic beads using the above fine metal particles. Because of a multi-layer coating structure, the above magnetic beads with two or more coatings are highly stable in a solvent. Accordingly, the magnetic beads of the present invention are suitably used in a biomaterial-extracting step in which they are exposed to a solvent. Further, high saturation magnetization reduces the biomaterial-recovering time with a magnetic force, exhibiting high extractability of biomaterials.

The method of the present invention for producing fine metal particles comprises the steps of coating each primary particle comprising a magnetic metal core particle and a first coating layer with a mixture of silicon alkoxide and aluminum alkoxide, and then hydrolyzing the silicon alkoxide and the aluminum alkoxide, thereby forming a coating layer comprising an oxide of silicon and aluminum.

The primary particle is preferably formed by mixing powder comprising an oxide of the magnetic metal with powder comprising at least one element selected from the group consisting of Si, V, Ti, Al, Nb, Zr and Cr, and heat-treating them in a non-oxidizing atmosphere. The first coating is preferably based on at least one element selected from the group consisting of Si, V, Ti, Al, Nb, Zr and Cr. The above method can easily produce the fine metal particles of the present invention, because it forms not only magnetic metal core particles but also the first coating layer comprising at least one element selected from the group consisting of Si, V, Ti, Al, Nb, Zr and Cr.

### BRIEF DESCRIPTION OF THE DRAWINGS

FIG. 1(a) is a schematic view showing one example of magnetic separation using a cylindrical vessel with a closed end.

FIG. 1(b) is a schematic view showing another example of magnetic separation using a cylindrical vessel with a closed end.

FIG. 1(c) is a schematic view showing the steps of extracting a nucleic acid by magnetic separation using a cylindrical vessel with a closed end.

FIG. 2(a) is a schematic view showing one example of magnetic separation using a microchip.

FIG. 2(b) is a schematic view showing the steps of extracting a nucleic acid by magnetic separation using a microchip.

FIG. 3 is a graph showing the relation between the amount of AIP added and an Al/Si ratio.

FIG. 4 is a graph showing the relation between the amount of AIP added and the bonding energy of Si₂ₚ.

FIG. 5 is a graph showing the relation between the amount of AIP added and a zeta potential.

FIG. 6 is a graph showing the relation between an Al/Si ratio and the amount of DNA extracted.

FIG. 7 is a graph showing the relation between a zeta potential and the amount of DNA extracted.

FIG. 8 is a schematic view showing the evaluation results of redispersibility in Examples 1 and 3, and Comparative Example 1.

FIG. 9 is a schematic view showing the evaluation results of redispersibility in Example 6, Comparative Examples 3 and 4, and Reference Example 1.

FIG. 10 is a graph showing the relation between the magnetic separation time and a particle-recovering ratio in Reference Example 1 and Comparative Example 3.

FIG. 11 is a graph showing the evaluation results of the nonspecific adsorption of hemoglobin in Example 1 and Comparative Example 1.

FIG. 12 is a graph for explaining a method of determining a 50% particle size and a 90% particle size from the particle size distribution and cumulative particle size distribution of particles.

FIG. 13 is a schematic view showing an electric double layer around a fine particle dispersed in a solution.

### DESCRIPTION OF THE BEST MODE OF THE INVENTION

### [1] Fine Metal Particles

(1) Structure

Each fine metal particle of the present invention comprises a magnetic metal core particle, and two or more coating layers formed on the core particle, the outermost layer among the two or more coating layers being a coating layer made of an oxide of silicon and aluminum.

(i) Magnetic Metal Core Particles

The magnetic metal core particles are preferably made of any of Fe, Co, Ni and their alloys, and their alloys and compounds with other elements. The core particles made of a magnetic metal having high saturation magnetization enable quick magnetic separation. To have particularly high saturation magnetization, the core particles are preferably based on Fe (Fe alone, or an Fe-based alloy or compound).

(ii) Outermost Coating Layer

The outermost layer is made of a complex oxide of silicon and aluminum. The amount of a nucleic acid collected by the magnetic beads largely depends on the surface conditions, etc. of the particles, and the formation of a coating layer made of an oxide of silicon and aluminum on the particle surface provides high nucleic-acid-extracting performance.

In the coating layer made of an oxide of silicon and aluminum, an Al/Si atomic ratio is preferably 0.01-0.2. The addition of aluminum to silicon at such a ratio increases the activity of a silicon oxide coating, resulting in improved extractability of biomaterials. When the Al/Si atomic ratio is less than 0.01, the addition of aluminum does not exert any substantial effects. When the Al/Si atomic ratio is more than 0.2, a lot of fine particles made only of Al oxide are formed in addition to aluminum contained in silicon oxide, reducing the amount of a biomaterial extracted.

The atomic ratio of Si and Al contained in the outermost coating layer is measured by X-ray photoelectron spectroscopy (XPS). Because the X-ray photoelectron spectroscopy can detect an energy spectrum on the very surface of each particle, for instance, it is suitable for measuring the composition of the outermost coating layer as thick as about several tens of nanometers to about several hundreds of nanometers.

(iii) Intermediate Coating Layer

Formed between the magnetic metal core particle and the outermost coating layer made of an oxide of silicon and aluminum is an intermediate coating layer made of an inorganic material, a resin, etc. Its material and number of layers are not particularly restricted. Because the intermediate coating layer preferably has excellent elution resistance in an adsorption liquid when the core particles are made of a metal, it preferably comprises at least one element selected from the group consisting of Si, V, Ti, Al, Nb, Zr and Cr. The oxides, etc. of these elements are particularly preferable. These elements advantageously form a high-crystallinity, dense layer. Particularly preferable is a titanium oxide-based coating, which can be dense and thick, exhibiting excellent elution resistance. In addition, the formation of a multilayer coating of different inorganic materials further improves dispersibility and elution resistance.

(2) Particle Size

To achieve good dispersibility, the 50% particle size [median diameter (d50) by volume] of the above fine metal particles is preferably 10 μm or less. Though not particularly restricted, the lower limit of the 50% particle size is preferably 0.1 μm or more to keep magnetic properties necessary for quickly conducting a magnetic separation operation such as the recovery and dispersion of a biomaterial with a magnetic force, when the fine metal particles are used as a nucleic-acid-extracting carrier. The 50% particle size is further preferably 0.1-8 μm, more preferably 0.2-5 μm. The 90% particle size [90% cumulative particle size (d90) by volume] of the fine metal particles is preferably 15 μm or less, further preferably 0.15-15 μm, more preferably 0.15-10 μm.

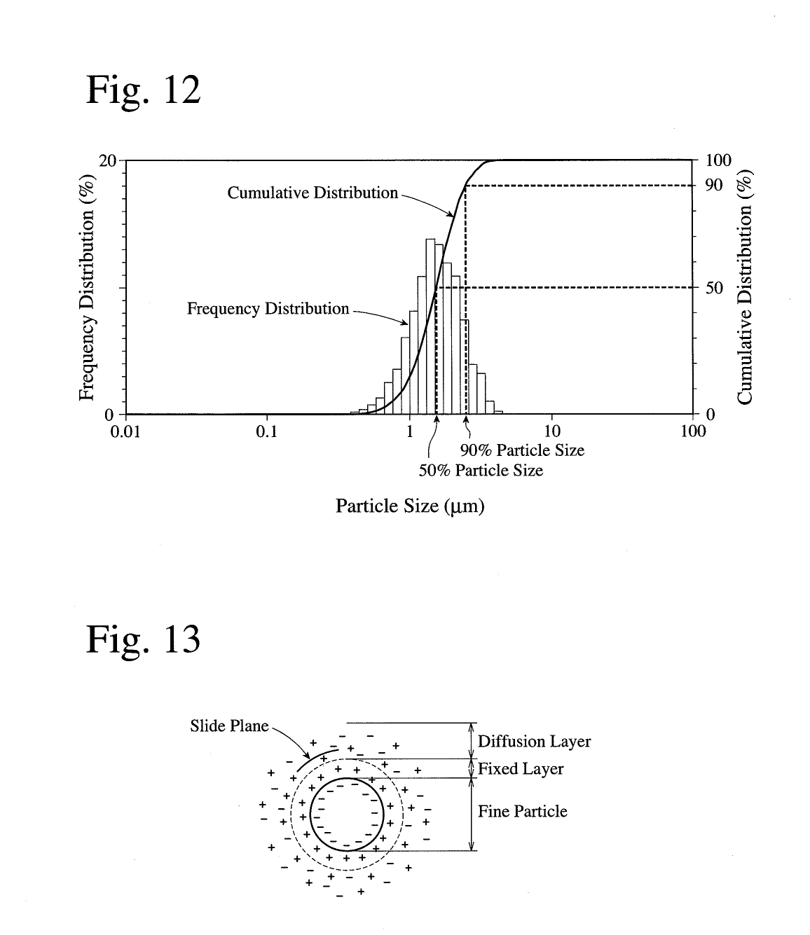

The 50% particle size and the 90% particle size can be determined from the particle size distribution of fine metal particles dispersed in a solvent, which is measured by a laser-diffraction scattering method. As shown in FIG. 12, the 50% particle size (d₅₀) and the 90% particle size (d₉₀) are a 50% cumulative particle size and a 90% cumulative particle size, respectively, in a cumulative distribution curve obtained from the measurement results of the particle size distribution. The 50% particle size is generally called “median diameter.” When the particle size is as small as 500 nm or less, a sample is observed by a transmission electron microscope or a scanning electron microscope to measure the particle size distribution, from which the 50% particle size and the 90% particle size are determined. In the microscopic method, 50 or more particles are preferably measured. The particle size (diameter) of each particle corresponds to an outer diameter of a fine particle having a coating layer. When the projected shape of a particle is not a circle, an average of the maximum diameter and the minimum diameter is regarded as a particle size of the fine particle.

(3) Properties

(i) Bonding Energy

In the coating layer made of an oxide of silicon and aluminum in each fine metal particle of the present invention, the bonding energy of Si₂ₚ measured by X-ray photoelectron spectroscopy is preferably 102.4-103.4 eV. Because the X-ray photoelectron spectroscopy can detect an energy spectrum on the very surface as described above, it is suitable for measuring the bonding energy of Si₂ₚ, which characterizes the bonding energy of Si in the outermost coating layer. When the bonding energy of Si₂ₚ is more than 103.4 eV, the coating layer is based on silicon oxide, exhibiting insufficient activity to biomaterials, if any. When the bonding energy of Si₂ₚ is less than 102.4 eV, the coating layer contains too much aluminum, the magnetic beads have low activity on the surface. With the bonding energy of Si₂ₚ in the above range, the magnetic beads have high activity to biomaterials, exhibiting high extractability of a biomaterial. The inclusion of aluminum in the silicon oxide coating makes the bonding energy of Si₂ₚ lower than a usual bonding energy of Si₂ₚ in silicon oxide, thereby increasing the amount of a biomaterial extracted. The formation of the oxide of silicon and aluminum can be confirmed by X-ray photoelectron spectroscopy.

(ii) Saturation Magnetization

The fine metal particles preferably have saturation magnetization of 80-200 A·m²/kg. With the saturation magnetization in this range, the recovery of a biomaterial with a magnetic force can be conducted in a short period of time. When the saturation magnetization is less than 80 A·m²/kg, the recovery of a biomaterial takes a long period of time. The coating of the magnetic metal particles with an inorganic material, etc. makes saturation magnetization lower than that of fine, magnetic metal particles alone, but when the saturation magnetization is more than 200 A·m²/kg, the coating is unlikely to be formed sufficiently, resulting in the deteriorated extractability of a biomaterial. The more preferred saturation magnetization is 100-200 A·m²/kg. When an oxide-type magnetic material such as magnetite is used for core, particles, the above saturation magnetization cannot be achieved, resulting in poor magnetic separation performance. Taking balance with elution resistance by the coating into consideration, the saturation magnetization is further preferably 100-180 A·m²/kg.

(iii) Zeta Potential

Each charged fine particle dispersed in a solution forms an electric double layer, which comprises a fixed layer formed on a fine particle surface and a diffusion layer existing around the fixed layer (see FIG. 13). When the fine particle moves in a solution, the fixed layer and part of the diffusion layer also move together with the fine particle. A plane in which this movement occurs is called “slide plane.” The potential difference between this slide plane and a portion of the solution sufficiently separate from an interface with a fine particle is called “zeta potential.” The zeta potential is an index for evaluating the dispersibility and aggregation of a dispersion, and the interaction and surface modification of fine particles. Because the zeta potential corresponds to electrostatic repulsion between particles, it is an effective index for the dispersibility of fine particles. As the zeta potential nears zero, fine particles are aggregated. On the contrary, when the fine particles are surface-modified to have larger zeta potential as an absolute value, fine particles have more dispersibility.

The zeta potential can be determined by measuring the moving speed of fine particles by a laser Doppler velocimetry, when an electric field is applied to the fine metal particles dispersed in water. It is herein measured on the fine metal particles dispersed in a 0.01-M aqueous KCl solution adjusted to pH 7.5. The zeta potential ζ(mV) is expressed by the Smoluchowski's equation: ζ=ηuₑ/∈∈₀, wherein η represents the viscosity (poise) of a liquid, uₑ represents the electrophoretic mobility (=V/E) of particles, V represents the moving speed (cm/sec) of fine particles, E represents voltage (V), ∈ represents the dielectric constant of a solution, and ∈₀ represents the dielectric constant of vacuum.

The zeta potential of the fine metal particles in a 0.01-M aqueous KCl solution of pH 7.5 is preferably −40 mV to −10 mV. When the zeta potential is adjusted in this range so that the fine metal particles can adsorb biomaterials such as DNA, etc. in an aqueous solution having pH of 6-8 in the extraction step of the biomaterials, good adsorbability of biomaterials to the fine metal particles and good aggregation stability of the fine metal particles are obtained. When the zeta potential is higher than −10 mV, the fine metal particles are easily aggregated in a solvent, resulting in low redispersibility of fine metal particles, and the fine metal particles have too large an adsorption force to the biomaterials so that the biomaterials are not easily detached from the fine metal particles, resulting in a smaller amount of biomaterials extracted. On the other hand, when the zeta potential of the fine metal particles is lower than −40 mV, the fine metal particles have a small adsorption force to the biomaterial despite excellent redispersibility in a solvent, resulting in a smaller amount of biomaterials extracted. The zeta potential is more preferably −30 mV to −17 mV, further preferably −30 mV to −27 mV.

The fine metal particles of the present invention have an optimized zeta potential, which is obtained by changing the state of Si bonded to the particle surface by adding Al to a silicon oxide coating on the outermost surface. This drastically improves the redispersibility of particles that was not achieved conventionally, despite the 50% particle size of 10 μm or less smaller than that of conventional silicon-oxide-coated magnetic beads.

### [2] Magnetic Beads

Each magnetic bead of the present invention is obtained by coating a magnetic metal particle with an oxide of silicon and aluminum, to capture a targeted biomaterial directly or indirectly via a surface-modified antibody, etc. The fine metal particles of the present invention are preferably used as magnetic beads.

### [3] Production Method of Fine Metal Particles and Magnetic Beads

(1) Primary Particles

(i) Inorganic Coating Layer

The method for producing primary particles each comprising a magnetic metal core particle and a coating layer based on at least one element selected from the group consisting of Si, V, Ti, Al, Nb, Zr and Cr will be explained below. Though not particularly restricted, the primary particles can be produced, for instance, by mixing powder containing an oxide of a magnetic metal with powder comprising at least one element selected from the group consisting of Si, V, Ti, Al, Nb, Zr and Cr, and heat-treating the resultant mixture in a non-oxidizing atmosphere. This step forms magnetic metal core particles, and a first coating based on at least one element selected from the group consisting of Si, V, Ti, Al, Nb, Zr and Cr. The non-oxidizing atmosphere may be, for instance, an inert gas such as Ar, He, etc., or a gas comprising H₂, N₂, CO₂, NH₃ or a mixture thereof.

In the heat treatment, when the standard free energy of formation ΔG_{M1-0} of an oxide of a magnetic metal element M1, and the standard free energy of formation ΔG_{M2-0} of an oxide of at least one element M2 selected from the group consisting of Si, V, Ti, Al, Nb, Zr and Cr meet the relation of ΔG_{M1-0}>ΔG_{M2-0}, the M1 oxide can be reduced by M2. For instance, when the M1 oxide (oxide of a magnetic metal) is Fe₂O₃, compounds having smaller standard free energy of formation ΔG_{M2-0} than ΔG_{Fe2O3}=−740 kJ/mol include SiO₂, V₂O₃, V₂O₅, V₃O₅, TiO₂, Ti₂O₃, Ti₃O₅, Al₂O₃, Nb₂O₅, ZrO₂, Cr₂O₃, etc. Accordingly, when the element M2 is selected from the group consisting of Si, V, Ti, Al, Nb, Zr and Cr, Fe₂O₃ is reduced to form Fe core particles, and a coating layer based on the element M2 is formed.

The particle size of the magnetic metal oxide may be selected depending on the particle sizes of the targeted fine metal particles or magnetic beads, but is preferably in a range of 1-1000 nm. To obtain Fe-based metal particles containing Co and/or Ni, a mixture of Fe oxide powder and powder of an oxide of Co and/or Ni, or powder of a compound comprising Fe, Co and oxygen and/or powder of a compound comprising Fe, Ni and oxygen can be used. The Fe oxide powder may be, for instance, Fe₂O₃, Fe₃O₄, or FeO, the Co oxide may be, for instance, Co₂O₃ or Co₃O₄, and the Ni oxide may be, for instance, NiO. The compound comprising Fe, Co and oxygen may be, for instance, CoFe₂O₄, and the compound comprising Fe, Ni and oxygen may be, for instance, NiFe₂O₄, etc.

The powder comprising at least one element selected from the group consisting of Si, V, Ti, Al, Nb, Zr and Cr may be made of this element (element M2) alone, or its carbide (M2-C), boride (M2-B) or nitride (M2-N). The particle size of the M2-containing metal powder is preferably in a range of 1 nm to 100 μm, more preferably in a range of 1 nm to 10 μm to conduct the reduction reaction further efficiently.

A mixing ratio of the oxide powder comprising Fe, Co and Ni to the powder comprising the element M2 is preferably near a stoichiometric ratio sufficient to reduce the oxide of Fe, Co and Ni. The M2-containing powder is more preferably more than the stoichiometric ratio. When the M2-containing powder is insufficient, the oxide comprising Fe, Co and Ni is not fully reduced during the heat treatment, and the M2 particles are finally sintered to a bulk.

The heat treatment can be conducted in a stationary electric furnace having heating tubes, a rotatable electric furnace such as a rotary kiln, an apparatus for heating fluidized powder like a fluidized bed, an apparatus for heating gravitationally falling fine particles by high-frequency plasma, etc. In any case, an oxide material is reduced to form a metal core and a first coating layer simultaneously.

The coating layer formed by a heating reaction is higher in crystallinity and density than those formed by a sol-gel method, etc., preventing the deterioration of the metal core particles by oxidation, etc. Accordingly, even when metals having poor corrosion resistance and oxidation resistance are used for cores, fine metal particles and magnetic beads having extremely high corrosion resistance and oxidation resistance can be obtained.

The use of such primary particles can remarkably prevent metal core particles from deteriorating in the step of forming a coating layer made of an oxide of silicon and aluminum on the first coating layer. Because the coating layer made of an oxide of silicon and aluminum prevents deterioration by oxidation, etc., the fine metal particles exhibit extremely high magnetic properties, corrosion resistance and oxidation resistance when used in a medium for extracting nucleic acids.

(ii) Resin Coating Layer

The metal core particle may be provided with a resin coating layer in place of or in addition to the above inorganic coating layer. The formation of a resin coating layer on the inorganic coating layer improves corrosion resistance, thereby suppressing the deterioration of saturation magnetization even in a high-concentration chaotropic salt solution. It also improves dispersibility because of the reduced specific gravity. The resin coating layer is preferably made of a thermoplastic resin. Pluralities of core particles with or without the inorganic coating may be embedded in a resin.

Though not particularly restricted, the thermoplastic resins may be polystyrene, polyethylene, polyvinyl chloride, polyamides, etc. The polyamides include nylon 6, nylon 12, nylon 66, etc. The thermoplastic resin may be a mixture of two or more resins.

The coating of a resin may be conducted by mixing a thermoplastic resin dispersion with core particles with or without an inorganic coating, heating the mixture at a temperature equal to or higher than the melting point of the thermoplastic resin, and cooling it to a temperature lower than the melting point. The thermoplastic resin is preferably dispersed in a medium having no compatibility with the thermoplastic resin. The dispersion medium may be polyalkylene oxide such as polyethylene glycol, polyvinyl alcohol, etc. alone or in combination. The heating is preferably conducted at a temperature higher than the melting point by 10-150° C. Too high a heating temperature causes the decomposition of the resin and the oxidation of the primary particles. Too low a heating temperature fails to form a uniform coating. Dispersion may be conducted in a blending machine such as a kneader, etc. After cooling to a temperature lower than the melting point, the resin-coated, fine metal particles (magnetic beads) can be separated by magnetic separation, etc.

The resin coating can be formed by the polymerization of a mono-functional vinyl monomer as a starting material. This mono-functional vinyl monomer may contain a polyfunctional vinyl monomer. This resin coating is particularly a polystyrene resin coating.

(2) Outermost Coating Layer

The coating layer made of an oxide of silicon and aluminum can usually be formed by a sol-gel method. The bonding energy of Si₂ₚ and the zeta potential in the coating layer made of an oxide of silicon and aluminum can be controlled by adjusting coating-layer-forming conditions (for instance, the amounts of silicon oxide and aluminum oxide).

The coating layer made of an oxide of silicon and aluminum can be obtained, for instance, by the hydrolysis reaction of silicon alkoxide and aluminum alkoxide. With the aluminum alkoxide as a starting material, aluminum easily forms a compound with silicon oxide.

Specific examples of silicon alkoxides include tetramethoxysilane, tetraethoxysilane, tetraisopropoxysilane, tetrabutoxysilane, methyltrimethoxysilane, methyltriethoxysilane, dimethyldiethoxysilane, dimethyldimethoxysilane, tetrapropoxysilane, phenyltriethoxysilane, etc. The tetraethoxysilane is particularly preferable, because it forms a high-insulation, inexpensive coating.

Specific examples of aluminum alkoxides include aluminum isopropoxide, aluminum trimethoxide, aluminum triethoxide, aluminum tributoxide, aluminum methyldimethoxide, aluminum methyldiethoxide, aluminum methyldibutoxide, aluminum phenyldimethoxide, aluminum phenyldimethoxide aluminum, etc. The aluminum isopropoxide is particularly preferable, because it easily forms a compound with silicon oxide and a dense coating.

Taking a combination of tetraethoxysilane and aluminum isopropoxide for example, the formation of a silicon compound coating will be explained. The primary particles coated with titanium oxide, etc. are dispersed in an alcohol containing tetraethoxysilane and aluminum isopropoxide. The alcohols are preferably lower alcohols such as ethanol, methanol, isopropanol, etc. 100-10000 parts by mass of alcohol is preferably used per 100 parts by mass of tetraethoxysilane and aluminum isopropoxide in total. With ammonia water added as a catalyst for accelerating the reaction, tetraethoxysilane and aluminum isopropoxide are hydrolyzed. The addition of ammonia water provides water in an amount more than needed for the 100-% hydrolysis of tetraethoxysilane and aluminum isopropoxide. Specifically, 2 mol or more of water is added to 1 mol of tetraethoxysilane and aluminum isopropoxide in total.

The total amount of tetraethoxysilane and aluminum isopropoxide per 100 parts by mass of the primary particles is preferably 5-150 parts by mass, more preferably 5-80 parts by mass, further preferably 10-60 parts by mass. When the total amount of tetraethoxysilane and aluminum isopropoxide is less than 5 parts by mass, the primary particles are not uniformly covered by a silicon compound coating. When it exceeds 150 parts by mass, a large amount of fine particles made only of a silicon compound, an aluminum compound, or a complex compound of silicon and aluminum without containing primary particles are formed, resulting in low efficiency of extracting biomaterials.

To obtain fine metal particles (magnetic beads) having high extractability of nucleic acids by adjusting the bonding energy of Si₂ₚ, etc., the percentage of aluminum isopropoxide to the total amount of tetraethoxysilane and aluminum isopropoxide is preferably 5-40% by mass, more preferably 5-25% by mass. The amount of water used for the hydrolysis of tetraethoxysilane and aluminum isopropoxide is preferably 17-1000 parts by mass per 100 parts by mass of the total amount of tetraethoxysilane and aluminum isopropoxide. When the amount of water used is less than 17 parts by mass, the hydrolysis of tetraethoxysilane and aluminum isopropoxide occurs slowly, resulting in low production efficiency. When it exceeds 1000 parts by mass, a large amount of isolated particles based on silicon oxide are formed. Assuming that the concentration of ammonia water used as a catalyst is 28%, the amount of the ammonia water is preferably 10-100 parts by mass per 100 parts by mass of the total amount of tetraethoxysilane and aluminum isopropoxide. When the amount of the ammonia water is less than 10 parts by mass, it does not exhibit a sufficient function as a catalyst. When it is more than 100 parts by mass, a large amount of isolated particles based on silicon oxide are formed. In the sol-gel method, the ammonia water used as a catalyst turns the solution weakly alkaline with pH of about 11, so that the metal particles may be corroded. However, the coating of titanium oxide, etc. formed on the primary particles prevents the corrosion of metal core particles while forming a silicon compound coating.

To form the coating layer made of an oxide of silicon and aluminum uniformly on the primary particles, the primary particles is sufficiently mixed with the solution using a ball mill, a V-type mixer, a motor stirrer, a dissolver or an ultrasonic apparatus, etc. Mixing should be conducted longer than a time period for sufficiently causing the hydrolysis reaction of tetraethoxysilane and aluminum isopropoxide. Because the fine metal particles (magnetic beads) of the present invention having a coating layer made of an oxide of silicon and aluminum exhibit sufficient performance, a heat treatment is not always necessary. However, to remove the remaining hydrate and to increase the strength of the coating layer, a heat treatment may be conducted. A heating temperature is equal to or higher than a temperature at which the hydrate can be removed, preferably 80-500° C. Also, by repeating the step of forming the coating layer made of an oxide of silicon and aluminum two times or more, the coating layer made of an oxide of silicon and aluminum can be made more uniform.

The thickness of the coating layer made of an oxide of silicon and aluminum is preferably 5-400 nm on average. To obtain a sufficient magnetic force, the saturation magnetization of the fine metal particles (magnetic beads) is preferably 50-100% of that of the magnetic metal core particles, but the thickness of more than 400 nm results in large decrease in the saturation magnetization, making it difficult to achieve such saturation magnetization. The thickness is more preferably 100 nm or less, further preferably 80 nm or less. When the thickness of the coating layer is 5 nm or less, the chemical properties of an oxide of silicon and aluminum are not sufficiently obtained, resulting in poor performance as a biomaterial-extracting medium. The chemical properties of the coating layer can be observed by measuring the surface potential (zeta potential).

The coating layer made of an oxide of silicon and aluminum should be formed on the outermost surface of each particle. For instance, the primary particle may be coated with only silicon oxide, and then with an oxide of silicon and aluminum.

The thickness of the coating layer made of an oxide of silicon and aluminum can be measured, for instance, by a transmission electron microscope. In the transmission-electron-microscopic observation of sample particles, the transmittance of electron beams largely differs between primary core particles and coatings made of an oxide of silicon and aluminum, generating contrast, which enables the measurement of the coating layer thickness. The thickness of coating layers in 10 or more particles is measured and averaged herein. In each particle, the thickness of a coating layer is measured at 4 or more points, and averaged.

The formation of the coating layer made of an oxide of silicon and aluminum on the primary particle surface can be confirmed, for instance, by element analysis such as energy-dispersive X-ray fluorescence spectrometry (EDX spectrometry), Auger electron spectroscopy, X-ray photoelectron spectroscopy, etc., or infrared spectroscopy. For instance, the measurement of a composition distribution of the coating layer in a radial direction by EDX spectrometry or Auger electron spectroscopy together with the transmission-electron-microscopic observation of the fine metal particles can confirm that the coating layer is made of an oxide of silicon and aluminum. Also, in the infrared absorption spectrum of the fine metal particles or magnetic beads, absorption peaks assigned to the oxide of silicon and aluminum are observed in a wavenumber range of 1250-2020 cm⁻¹, thereby confirming the formation of the coating layer made of an oxide of silicon and aluminum.

When the coating layer made of an oxide of silicon and aluminum is formed by the hydrolysis reaction of tetraethoxysilane and aluminum isopropoxide, the thickness of the coating layer depends not only on the amounts of tetraethoxysilane and aluminum isopropoxide used, but also on the amounts of water, catalyst, etc. However, if these amounts are excessive, the resultant coating layers would be thick, and particles made only of excessive silica not forming the coating layer would be undesirably formed. The thickness of the coating layer made of an oxide of silicon and aluminum is increased by adding an electrolyte such as KCl, NaCl, LiCl, NaOH, etc. in the reaction.

### [4] Method for Extracting Nucleic Acids from Biomaterials

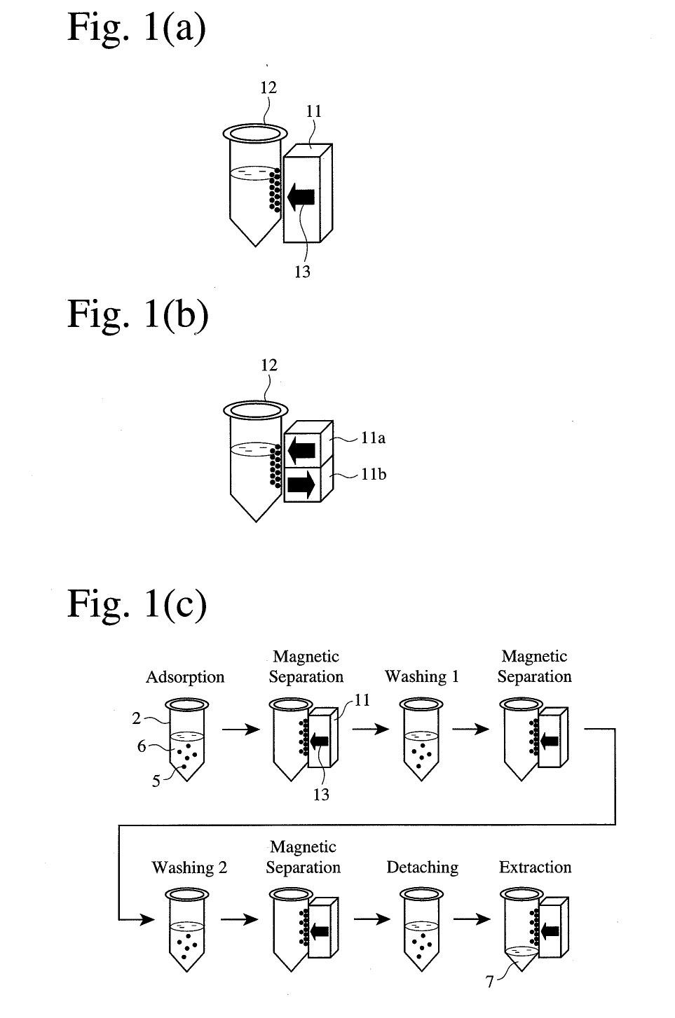

Using the magnetic beads of the present invention, target materials such as nucleic acids, etc. can be extracted and isolated from biomaterials. This method is called a magnetic separation method, in which a permanent magnet is put close to an outer wall of a vessel containing magnetic beads and a reagent to apply a magnetic field to collect the magnetic beads (see, for instance, JP 9-19292 A). As shown in FIG. 1(a), magnetic beads, a nucleic-acid-containing sample, and an extraction liquid are charged into a cylindrical vessel 12 with a closed end, and a permanent magnet is put close to an outer wall of the vessel to apply a magnetic force 13, such that the nucleic-acid-adsorbed magnetic beads gather near a side surface of the vessel 12, thereby separating the magnetic beads from the solution. The permanent magnet may be a single permanent magnet 11 as shown in FIG. 1(a), or a combination of pluralities of permanent magnets 11a, 11b as shown in FIG. 1(b).

The extraction of a nucleic acid by a magnetic separation method, which comprises steps A1 to A6 below, will be explained in detail referring to FIG. 1(c).

(A1) Magnetic beads 5, a nucleic-acid-containing sample, and an extraction liquid are charged into a vessel 2, and mixed by vibrating the vessel (adsorption).

(A2) Magnetic separation is conducted to keep the nucleic-acid-adsorbed magnetic beads 5 at an inner wall of the vessel, while removing other materials than the target material remaining in a solvent 6 after extraction (magnetic separation).

(A3) With a washing solvent added, the vessel is vibrated, and magnetic separation is then conducted to wash away other materials than the target material (washing step 1 and magnetic separation).

(A4) The washing and magnetic separation in the above step A3 are repeated predetermined times (washing step 2 and magnetic separation). Although FIG. 1(c) shows two washing steps, they may be further repeated if necessary; the washing steps being preferably conducted 2-5 times.

(A5) With a solvent for detaching the nucleic acid from the magnetic beads added, the vessel is vibrated to separate the nucleic acid from the magnetic beads (detaching).

(A6) Magnetic separation is conducted to separate the magnetic beads from an extraction liquid 7, a solvent containing the nucleic acid (extraction).

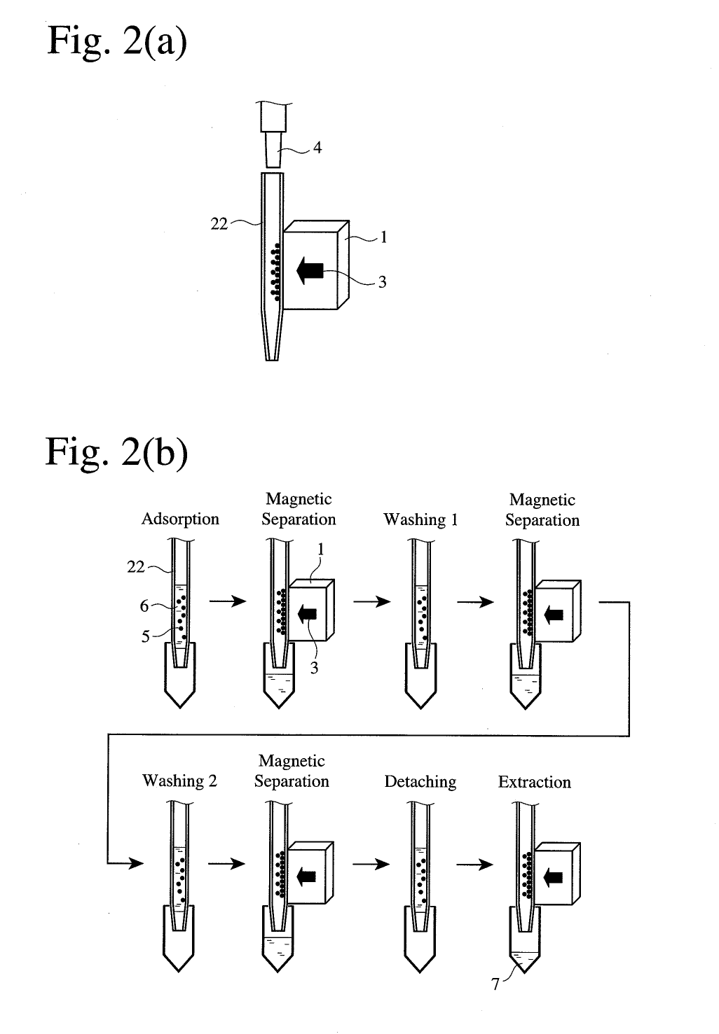

As described in WO 97/44671, the magnetic beads can be collected by a microchip. As shown in FIG. 2(a), a solvent-sucking dispenser 4 is attached to one side of the microchip 2 to suck, through an opposing tip opening, magnetic beads, a nucleic-acid-containing sample, and an extraction liquid in another vessel, and the suction and discharging of a solvent is continuously conducted such that the magnetic beads are dispersed in the solvent. Thereafter, a suspension of the magnetic beads is sucked into the microchip 2, and a permanent magnet 1 is put close to an outer wall of the vessel in a state where the suspension remains in the microchip 2, or while conducting the suction and discharging of the solution, thereby conducting the magnetic separation of the magnetic beads.

The magnetic separation method using a microchip are conducted by the following steps B1 to B6.

(B1) By repeating the suction and discharging, a mixture solution comprising magnetic beads 5, a nucleic-acid-containing sample, and an extraction liquid is stirred (adsorption).

(B2) Magnetic separation is conducted to remove other materials than the target material remaining in the solvent after extraction, while keeping the nucleic-acid-adsorbed magnetic beads at an inner surface of the vessel (magnetic separation).

(B3) A washing solvent is repeatedly sucked and discharged for magnetic separation, and other materials than the target material is washed away (washing step 1 and magnetic separation).

(B4) The washing and magnetic separation in the above step B3 are repeated predetermined times (washing step 2 and magnetic separation). Although FIG. 1(c) shows two washing steps, they may be further repeated if necessary; the washing steps being preferably conducted 2-5 times.

(B5) The suction and discharging of a solvent for detaching the nucleic acid from the magnetic beads are repeated to detach the nucleic acid from the magnetic beads (detaching).

(B6) Magnetic separation is conducted to separate the magnetic beads from an extraction liquid 7, a solvent containing the nucleic acid (extraction).

Taking DNA for example, a method for measuring the amount of a nucleic acid extracted from a nucleic-acid-containing sample, such as blood, etc., will be explained. Because DNA-constituting bases have absorption peaks near 260 nm, the amount of DNA can be determined by measuring the absorbance of an extraction liquid. The concentration of DNA in the extraction liquid can be calculated from the absorbance of DNA at 260 nm, thereby determining the amount of DNA collected. In the extraction step of DNA, the amounts of other materials (impurities) than DNA, such as proteins, contained in the extraction liquid should be small. Because proteins have strong absorption near 280 nm, the purity of DNA in the extraction liquid can be determined from a ratio (OD 260 nm/OD 280 nm) of the absorption of DNA at 260 nm (OD 260 nm) to the absorption of proteins at 280 nm (OD 280 nm). When the DNA-extracted liquid contains reagents having absorption peaks in a wide range near 260 nm, failing to determine the accurate concentration of DNA by an absorbance method, it is preferable to selectively dye a nucleic acid with a fluorescent reagent to measure its fluorescence intensity, thereby determining the concentration of the nucleic acid.

The present invention will be described in detail with reference to Examples below without intension of limitation.

### Example 1

TiC powder and Fe₂O₃ powder were mixed, and heat-treated at 800° C. for 8 hours in nitrogen to produce Ti-oxide-coated, primary Fe particles (50% particle size: 1.5 μm). 5 g of the primary particles were dispersed in 100 ml of an ethanol solvent, to which tetraethoxysilane (TEOS) and aluminum isopropoxide (AIP) were added in amounts shown in Table 1. A mixture solution containing 22.52 g of ion-exchanged water, 4.57 g of 28% ammonia water and 0.03 g of KCl was dropped to this solvent while stirring, over 5 minutes. Thereafter, stirring was continued for an hour to conduct the hydrolysis of TEOS and AIP. After completion of the reaction, washing with IPA was conducted three times, and filtration was then conducted for solid-liquid separation. The solid was dried by heating at 30° C. or higher in the air, to obtain fine metal particles coated with an oxide of silicon and aluminum.

### Examples 2-5 and Comparative Examples 1 and 2

Fine metal particles of Examples 2-5 and Comparative Examples 1 and 2 were produced in the same manner as in Example 1 except for changing the amounts of tetraethoxysilane (TEOS) and aluminum isopropoxide (AIP) as shown in Table 1. In Comparative Example 1, a coating layer was formed only with tetraethoxysilane without using aluminum isopropoxide.

The resultant fine metal particles of Examples 1-5 and Comparative Examples 1 and 2 were measured with respect to a 50% particle size, a 90% particle size, the bonding energy of Si₂ₚ, an Al/Si ratio, a zeta potential, and magnetic properties, and the extractability and redispersibility of DNA were evaluated when they were used as biomaterial-extracting magnetic beads. The results are shown in Table 1.

Evaluation Method

(1) Measurement of Particle Size

The 50% particle size (d₅₀) and the 90% particle size (d₉₀) were measured by a laser-diffraction-type particle size distribution analyzer (LA-920 available from Horiba).

(2) Bonding Energy of Si₂ₚ

The bonding of silicon in the coating was measured by X-ray photoelectron spectroscopy, using AXIS-HS available from Kratos (X-ray source: monochromatic aluminum Kα line, and spot diameter: 400 μm). The detector had an analyzer pass energy of 100 eV and a measurement resolution of about 0.9 eV at a peak of Ag_{3d5/2}.

(3) Al/Si Ratio

The Al/Si ratio was determined from a spectrum intensity ratio of Al to Si measured by X-ray photoelectron spectroscopy under the same conditions as those of the bonding energy of Si₂ₚ.

(4) Zeta Potential

Fine metal particles were dispersed in a 0.01-M aqueous KCl solution adjusted to pH 7.5, and their zeta potential was measured by a zeta potentiometer DELSA440 available from Beckman Coulter, Inc.

(5) Magnetic Properties

The magnetic properties (saturation magnetization and coercivity) of the fine metal particles at 25° C. were measured by a vibration sample magnetometer (VSM) in a magnetic field of 1.6 MA/m.

(6) Extractability of DNA

The extractability of DNA from whole blood with the magnetic beads was evaluated using MagnaPure LC DNA Isolation Kit I (registered trademark) commercially available from Roche Diagnostics as a nucleic acid extraction kit. 100 μl of horse blood was introduced into a 2-ml micro-tube, and after 100 μl of a Proteinase K solution and 300 μl of a Lysis binding buffer attached to this kit were added, the horse blood was agitated at room temperature for 3 minutes. 20 mg of the magnetic beads were dispersed in 150 μl of 99.5-% isopropyl alcohol to prepare a magnetic bead dispersion. The dispersion was introduced into the above micro-tube, and agitated at room temperature for 8 minutes to have the magnetic beads adsorb DNA. Thereafter, it was washed with 850 μl of Wash Buffer I attached to the above kit for magnetic solid-liquid separation. It was then washed with 450 μl of Wash Buffer II attached to the above kit for magnetic solid-liquid separation. Washing with Wash Buffer II was conducted twice. To detach DNA from the magnetic beads, the DNA-adsorbed magnetic beads were dispersed in 100 μl of Elution Buffer attached to the above kit, and agitated at room temperature for 8 minutes for solid-liquid separation to collect a DNA-extracted solution. In the above step, the solid-liquid separation was conducted by a magnetic separation method. The absorbance of the DNA-extracted solution at a wavelength of 260 nm was measured to determine the amount of DNA extracted, thereby evaluating the extractability of DNA.

(7) Redispersibility

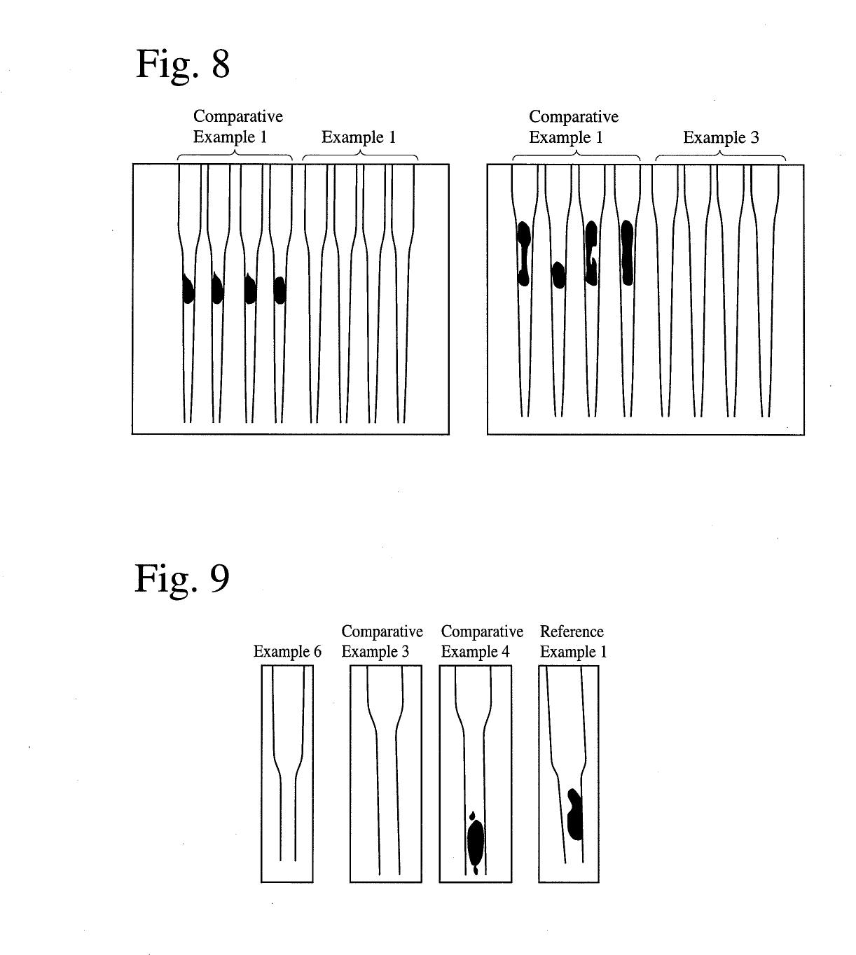

As shown in FIG. 2(b), a DNA-extracting operation was conducted by a method of applying a magnetic field to the magnetic beads from outside the microchip to magnetically collect the magnetic beads, and the conditions of the magnetic beads in the microchip were observed after the second washing step (washing step 2) to evaluate the redispersibility of magnetic beads. The magnetic beads did not remain in the microchip in the case of a sample having good redispersibility (Example 1 in FIG. 8), while the magnetic beads were aggregated in the microchip in the case of a sample having poor redispersibility (Comparative Example 1 in FIG. 8).

TABLE 1

| | TEOS | AIP | AIP | Al/Si | 50% Particle | 90% Particle | Si₂ₚ |
|---|---|---|---|---|---|---|---|
| No. | (g) | (g) | (% by mol) | Ratio | Size (μm) | Size (μm) | (eV) |
| Example 1 | 1.00 | 0.05 | 5 | 0.02 | 1.6 | 2.5 | 103.4 |
| Example 2 | 0.95 | 0.11 | 10 | 0.09 | 1.6 | 3.9 | 103.3 |
| Example 3 | 0.89 | 0.16 | 15 | 0.09 | 1.6 | 2.4 | 103.3 |
| Example 4 | 0.79 | 0.26 | 25 | 0.17 | 1.4 | 2.4 | 102.4 |
| Example 5 | 0.69 | 0.36 | 30 | — | 1.4 | 2.4 | 102.6 |
| Comparative | 1.05 | 0.00 | 0 | 0.00 | 2.7 | 4.9 | 103.5 |
| Example 1 | | | | | | | |
| Comparative | 0.52 | 0.53 | 50 | 0.31 | 1.7 | 2.9 | 102.2 |
| Example 2 | | | | | | | |

| | Zeta | | | Saturation | |
|---|---|---|---|---|---|
| | Potential | DNA | | Magnetization | Coercivity |
| No. | (mV) | Extracted (μg) | Redispersibility | (A · m²/kg) | (kA/m) |
| Example 1 | −30 | 2.1 | Good | 120 | 5.3 |
| Example 2 | −27 | 1.9 | — | 125 | 5.3 |
| Example 3 | — | 1.8 | Good | 127 | 5.2 |
| Example 4 | −17 | 1.7 | — | 129 | 5.4 |
| Example 5 | — | — | — | 130 | 5.3 |
| Comparative | −42 | 1.5 | Poor | 118 | 5.5 |
| Example 1 | | | | | |
| Comparative | −5 | 1.4 | — | 132 | 5.3 |
| Example 2 | | | | | |

Note:
Blank indicates “not measured.”

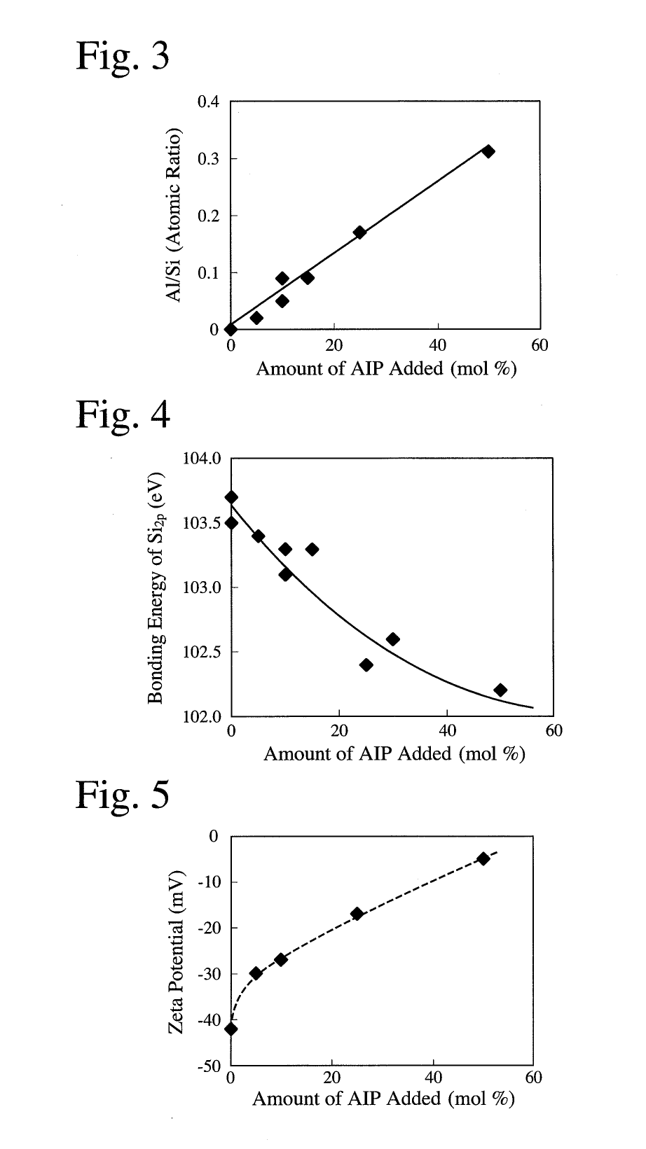

FIGS. 3-5 are graphs showing the relations between the amount of AIP added and an Al/Si ratio, the bonding energy of Si₂ₚ and a zeta potential, respectively. The amount of AIP added has good correlation with the Al/Si ratio (FIG. 3), indicating that a coating layer having an as-designed surface composition was formed. The relation between the amount of AIP added and the bonding energy of Si₂ₚ (FIG. 4) indicates that the bond of Si—O—Al was formed depending on the amount of AIP added. The relation between the amount of AIP added and the zeta potential (FIG. 5) suggests that the addition of a trace amount of AIP changed the zeta potential drastically, and that AIP changed the surface conditions of the fine metal particles.

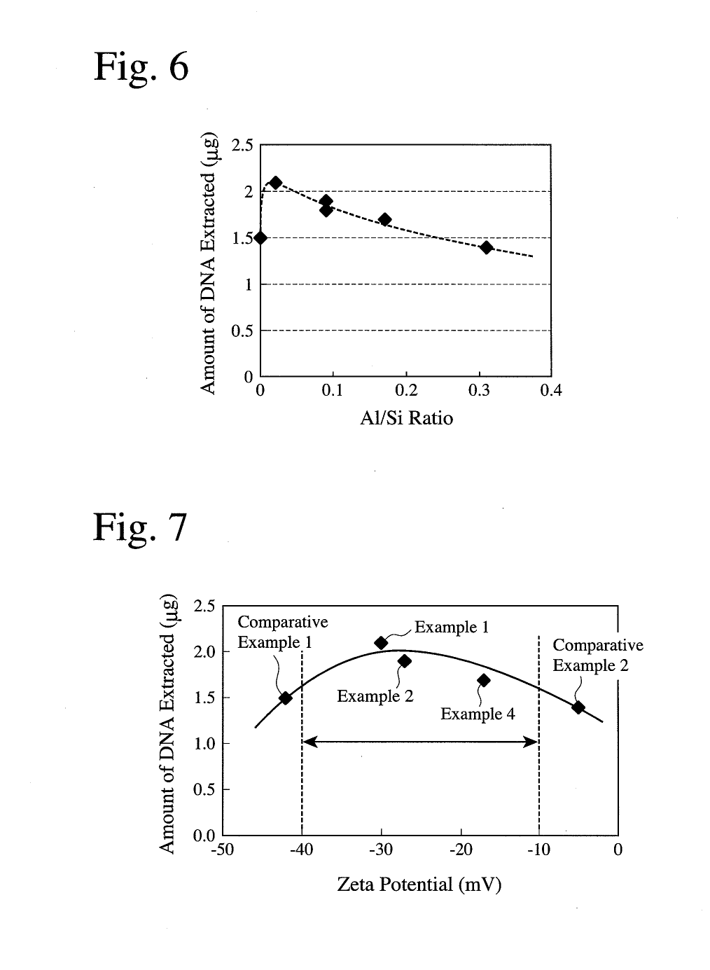

FIG. 6 shows the relation between the Al/Si ratio and the amount of DNA extracted. DNA was extracted more by the magnetic beads (fine metal particles) of Examples 1-4 each having a coating layer formed with AIP added than by the magnetic beads (fine metal particles) of Comparative Example 1 containing no aluminum, indicating that the former exhibited better performance. This result indicates that particularly the magnetic beads (fine metal particles) with coating layers having an Al/Si ratio of 0.01-0.2 had excellent extractability of DNA.

Because the zeta potential is a property parameter acting as an index for evaluating the dispersion stability of particles in a solution, and their absorbance of biomaterials, etc., the relation between the zeta potential and the amount of DNA extracted was investigated in each sample. The results are shown in FIG. 7. FIG. 7 shows that the relation between the amount of DNA extracted and the zeta potential of the magnetic beads was expressed by an upward-projecting curve having a peak near −30 mV, and that DNA was extracted more by the magnetic beads of Examples 1, 2 and 4 having coating layers formed with AIP added than the magnetic beads of Comparative Example 1 having the outermost coating layer not containing Al, indicating that the former exhibited better performance. However, the magnetic beads of Comparative Example 2 having more AIP added had rather decreased extractability of DNA. These results suggest that the magnetic beads of Comparative Example 1 having a conventional coating layer made only of silica extracted a smaller amount of DNA because of a low adsorption force to the biomaterial, and that the magnetic beads of Comparative Example 2 with a larger amount of AIP added also extracted a smaller amount of DNA because of easy aggregation in a solvent and too large an adsorption force to detach the biomaterial. It is thus considered that the magnetic beads having a zeta potential in a range of −40 mV to −10 mV have a good balance of an adsorption force and dispersion stability, exhibiting high extractability of DNA.

The evaluation of the redispersibility of magnetic beads magnetically separated in the DNA-extracting operation confirmed, as shown in FIG. 8, that the magnetic beads of Examples 1 and 3 within the present invention were not aggregated in the microchip, exhibiting good redispersibility. On the other hand, the AIP-free magnetic beads of Comparative Example 1 were aggregated, exhibiting poor redispersibility. Also, the magnetic beads (fine metal particles) of the present invention had high saturation magnetization and low coercivity.

### Example 6

Fine metal particles were produced in the same manner as in Example 1 except for using Ti-oxide-coated, fine Fe particles (primary particles) having a 50% particle size of 5.3 μm. The particle size and redispersibility of the fine metal particles, and the amount of DNA extracted when they were used as magnetic beads are shown in Table 2. The magnetic beads (fine metal particles) of Example 6 had a 50% particle size of 6.4 μm and a 90% particle size of 9.6 μm, and exhibited the same extractability of DNA as that of Example 1, and good redispersibility.

### Comparative Example 3

The evaluation of commercially available silica-coated iron oxide particles indicates that they had saturation magnetization of 44 A·m²/kg, coercivity of 11.5 kA/m, a 50% particle size of 12.9 μm, and a 90% particle size of 20.9 μm. Composition analysis revealed that the outermost surface contained Al, B, Zn, K and Na, with an Al/Si atomic ratio of 0.23.

### Comparative Example 4

The commercially available silica-coated iron oxide particles of Comparative Example 3 were classified by a sieve to remove coarse particles, thereby obtaining particles having a 50% particle size of 11.6 μm and a 90% particle size of 17.0 μm.

### Reference Example 1

Fine metal particles were produced in the same manner as in Comparative Example 1 except for using Ti-oxide-coated, fine Fe particles (primary particles) having a 50% particle size of 5.3 μm.

The redispersibility of the particles of Example 6, Comparative Examples 3, 4 and Reference Example 1 was evaluated. The results are shown in Table 2 and FIG. 9. The particles of Comparative Example 4 each comprising an iron oxide core and an aluminum-containing silicon oxide coating and the magnetic beads (fine metal particles) of Reference Example 1 were attached to an inner surface of the microchip, confirming that they had poor redispersibility. On the other hand, the magnetic beads (fine metal particles) of Example 6 were not aggregated, showing good redispersibility. The iron oxide particles of Comparative Example 3 were not aggregated. The particles of Comparative Example 4 obtained by removing coarse particles from the particles of Comparative Example 3 by classification by a sieve had a particularly small 90% particle size. This result confirms that even aluminum-containing, silica-coated iron oxide particles would exhibit poor redispersibility in the extraction step of DNA, if coarse particles were removed to prevent sedimentation during storing.

TABLE 2

| | 50% Particle | | 50% | 90% | DNA | |
|---|---|---|---|---|---|---|
| | Size of Cores | AIP | Particle | Particle | Extracted | |
| No. | (μm) | (% by mol) | Size (μm) | Size (μm) | (μg) | Redispersibility |
| Example 1 | 1.5 | 5 | 1.6 | 2.5 | 2.1 | Good |
| Example 6 | 5.3 | 5 | 6.4 | 9.6 | 2.1 | Good |
| Comparative | Unknown | Unknown | 12.9 | 20.9 | — | Good |
| Example 3 | | | | | | |
| Comparative | Unknown | Unknown | 11.6 | 17.0 | — | Poor |
| Example 4 | | | | | | |
| Reference | 5.3 | 0 | 1.7 | 10.9 | — | Poor |
| Example 1 | | | | | | |

Note:
Blank indicates “not measured.”

Response of Fine Particles to Magnetic Field

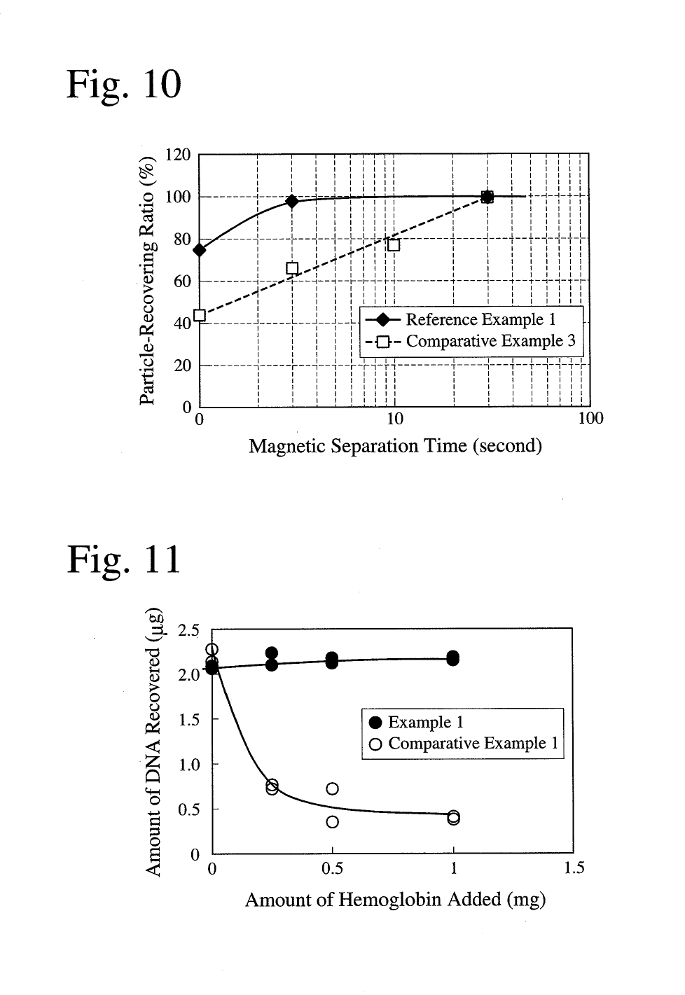

The response of the magnetic beads of Reference Example 1 and the silica-coated iron oxide particles of Comparative Example 3 to a magnetic field was evaluated. FIG. 10 shows the relation between magnetic-field-applying time and a particle-recovering ratio in the magnetic separation of particles. Magnetic separation was conducted 4 times for each time period to measure the weight of the finally remaining particles, thereby determining a particle-recovering ratio. The particles of Comparative Example 3 had low saturation magnetization because they contained iron oxide as a magnetic body, so that it took 30 seconds or more to collect all particles magnetically. On the other hand, the particles of Reference Example 1 had high saturation magnetization because they contained fine iron particles as a magnetic body, so that it took only 3 seconds to collect substantially 100% particles. Accordingly, the magnetic beads of the present invention having magnetic metal core particles as a magnetic body can drastically reduce a magnetic separation time.

Nonspecific Adsorbability

The nonspecific adsorption (property of adsorbing other biomaterials than the target on the surface) of the magnetic beads of Example 1 and Comparative Example 1 was evaluated. Used herein were 100 μl of a TE (10-mM Tris-HCl and 1-mM EDTA-2Na) solution containing 2.5 μg of purified λDNA, and a solvent containing, as a material to be examined, a predetermined amount of hemoglobin, a component in whole blood, which hindered the extraction of a nucleic acid. FIG. 11 shows the relation between the amount of hemoglobin added and the amount of DNA recovered. In the case of the magnetic beads of Comparative Example 1 coated with only silica, the amount of DNA recovered was remarkably reduced when 0.25 mg or more of hemoglobin was added. In the case of the magnetic beads of Example 1, the amount of DNA recovered did not change even when 1 mg of hemoglobin was added. This indicates that the magnetic beads of Example 1 each having a coating layer containing an oxide of silicon and aluminum suppresses the nonspecific adsorption of hemoglobin, which hinders the extraction of a nucleic acid.

### Reference Example 2

Primary particles were produced with the formulation of starting materials for Ti-oxide-coated Fe particles changed as shown in Table 3. The 50% particle size, magnetic properties and constituent elements of the resultant primary particles are shown in Table 3.

TABLE 3

| | Formulation of Starting | | | TiN | |
|---|---|---|---|---|---|
| | Material (% by mass) | | | Substitution | 50% Particle |
| No. | Fe₂O₃ | TiC | TiN | Ratio | Size (μm) |
| Reference | 70 | 30 | 0 | 0.0 | 4.4 |
| Example 2-A | | | | | |
| Reference | 70 | 27 | 3 | 0.1 | 3.3 |
| Example 2-B | | | | | |
| Reference | 70 | 24 | 6 | 0.2 | 3.2 |
| Example 2-C | | | | | |
| Reference | 70 | 21 | 9 | 0.3 | 3.7 |
| Example 2-D | | | | | |
| Reference | 70 | 18 | 12 | 0.4 | 5.0 |
| Example 2-E | | | | | |
| Reference | 70 | 15 | 15 | 0.5 | 3.9 |
| Example 2-F | | | | | |

| | |
|---|---|
| Magnetic Properties | Elements Contained |

| | | |
|---|---|---|
| Ms | iHc | (% by mass) |

| No. | (Am²/kg) | (kA/m) | C | N |
|---|---|---|---|---|
| Reference | 136 | 5.3 | 1.7 | 0.23 |
| Example 2-A | | | | |
| Reference | 140 | 5.2 | 1.4 | 0.17 |
| Example 2-B | | | | |
| Reference | 143 | 5.2 | 1.1 | 0.12 |
| Example 2-C | | | | |
| Reference | 151 | 4.7 | 0.9 | 0.09 |
| Example 2-D | | | | |
| Reference | 158 | 4.5 | 0.5 | 0.04 |
| Example 2-E | | | | |
| Reference | 106 | 1.6 | 0.2 | 0.04 |
| Example 2-F | | | | |

### EFFECT OF THE INVENTION

The fine metal particles and magnetic beads of the present invention have excellent chemical stability and high extractability of nucleic acids. Because each fine metal particle has a coating layer made of an oxide of silicon and aluminum, the particles have drastically improved aggregation stability and excellent redispersibility, thereby excellent nucleic-acid-recovering performance.

1-10. (canceled)

11. Fine metal particles each comprising a magnetic metal core particle and two or more coating layers, the outermost layer among said two or more coating layers containing an oxide of silicon and aluminum at an Al/Si atomic ratio of 0.01-0.2.

12. The fine metal particles according to claim 11, having a 50% particle size [median diameter (d50) by volume] of 0.1-10 μm.

13. The fine metal particles according to claim 11, having a 90% particle size (90% cumulative particle size by volume) of 0.15-15 μm.

14. The fine metal particles according to claim 11, wherein said core particle comprises at least one magnetic metal selected from the group consisting of Fe, Co and Ni.

15. The fine metal particles according to claim 12, wherein said core particle comprises at least one magnetic metal selected from the group consisting of Fe, Co and Ni.

16. The fine metal particles according to claim 13, wherein said core particle comprises at least one magnetic metal selected from the group consisting of Fe, Co and Ni.

17. The fine metal particles according to claim 11, having a zeta potential of −40 mV to −10 mV in a 0.01-M aqueous KCl solution of pH 7.5.

18. The fine metal particles according to claim 11, having saturation magnetization of 80-200 A·m²/kg.

19. The fine metal particles according to claim 11, wherein the innermost coating layer among said two or more coating layers, which is in contact with said magnetic metal core particle, is based on at least one element selected from the group consisting of Si, V, Ti, Al, Nb, Zr and Cr.

20. Biomaterial-extracting magnetic beads using the fine metal particles recited in claim 11.

21. A method for producing fine metal particles comprising the steps of coating each primary particle comprising a magnetic metal core particle and a first coating layer with a mixture of silicon alkoxide and aluminum alkoxide, and then hydrolyzing the silicon alkoxide and the aluminum alkoxide, thereby forming a second coating layer comprising an oxide of silicon and aluminum at an Al/Si atomic ratio of 0.01-0.2.

22. The method for producing fine metal particles according to claim 21, wherein said primary particle is formed by mixing powder comprising an oxide of said magnetic metal with powder comprising at least one element selected from the group consisting of Si, V, Ti, Al, Nb, Zr and Cr, and heat-treating them in a non-oxidizing atmosphere.
